(19) United States
(12) Patent Application Publication
(10) Pub. No.: US 2017/0187986 A1
(43) Pub. Date: Jun. 29, 2017

(54) Live streaming media method, publish side live, server and terminal

(71) Applicants: Le Holdings (Beijing) Co., Ltd., Beijing (CN); LE SHI INTERNET INFORMATION&TECHNOLOGY CORP., BEIJING, Beijing (CN)

(72) Inventor: Qi ZHANG, Beijing (CN)

(21) Appl. No.: 15/241,873

(22) Filed: Aug. 19, 2016

Related U.S. Application Data
(63) Continuation of application No. PCT/CN2016/088645, filed on Jul. 5, 2016.

(30) Foreign Application Priority Data
Dec. 23, 2015 (CN) 201510980686X

(51) Int. Cl. H04N 7/14; H04N 7/15

(52) U.S. Cl. CPC H04N 7/147; H04N 7/15

(57) ABSTRACT

Disclosed are a method, a publish side, a client and a system for live broadcasting streaming media. The method comprises: collecting live streaming media data from a media channel on a live channel, wherein the live streaming media data includes at least two paths; encoding the live streaming media data; and placing the encoded live streaming media data in a buffer corresponding to the live channel on the service platform, wherein, the encoded live streaming media data are respectively saved according to the media channel.

### CROSS REFERENCE TO RELATED APPLICATIONS

The present application is a continuation of PCT application which has an application number of PCT/CN2016/088645 and was filed on Jul. 5, 2016. This application is based upon and claims priority to Chinese Patent Application No. 201510980686X, titled “LIVE STREAMING MEDIA METHOD, PUBLISH SIDE, CLIENT AND SYSTEM LIVE”, filed Dec. 23, 2015, the entire contents of which are incorporated herein by reference.

### TECHNICAL FIELD

The invention relates to the field of streaming media processing technologies, and in particular, to a live streaming media method, publishes side live server and terminal.

### BACKGROUND

The existing mobile streaming media service mainly includes two categories: on demand and live broadcast. Wherein, during remote teaching and remote conference, a live streaming media service is used mostly. In the existing live streaming media service, the application of two-path sub-media stream based on voice and video is supported. For example, in a practical remote teaching scene, a publish side of a live streaming media system will live broadcast the voice and video information of a teacher to a client of the live streaming media system, thus the client of the live streaming media system may hear the voice of the teacher on line and watch the video information of the teacher on line, just as on site.

However, during the implementation of the invention, the inventors find that the live streaming media service in the related art only supports the transmission of two-path streaming media data, i.e., voice and video, thus it cannot meet the demand of multi-path streaming media data transmission in practical application. For example, in a real-time teaching scene, the transmission of the streaming media data of the content of a course explained by the teacher is generally required in addition to the streaming media data of voice and video; however, at this point, the existing streaming media data transmission solution cannot meet the demand of multi-path streaming media data transmission.

### SUMMARY

An embodiment of the application provides a live streaming media method, which is applied to a server, wherein the method includes: collecting live streaming media data from a media channel on a live channel, wherein the live streaming media data comprises at least two paths; encoding the live streaming media data; and placing the encoded live streaming media data into a buffer corresponding to the live channel on a service platform, wherein the encoded live streaming media data are respectively saved according to the media channel.

An embodiment of the application further provides a live streaming media method, which is applied to a terminal, wherein the method includes: acquiring an identification of a live channel for broadcasting a live streaming media from a service platform according to an attribute parameter of the live streaming media to be watched; acquiring the live streaming media data from a buffer corresponding to the live channel in the service platform according to the identification of the live channel, wherein the live streaming media data comprises at least two paths; decoding the live streaming media data; and playing the live streaming media data according to the decoded live streaming media data.

An embodiment of the application further provides a server, including: at least one processor; and a memory communicably connected with the at least one processor for storing instructions executable by the at least one processor, wherein execution of the instructions by the at least one processor causes the at least one processor to: collect live streaming media data from a media channel on a live channel, wherein the live-streaming media data comprises at least two paths; encode the live streaming media data; and place the encoded live streaming media data into a buffer corresponding to the live channel on a service platform, wherein the encoded live streaming media data are respectively saved according to the media channel.

An embodiment of the application further provides a terminal, including: at least one processor; and a memory communicably connected with the at least one processor for storing instructions executable by the at least one processor, wherein execution of the instructions by the at least one processor causes the at least one processor to: acquire an identification of a live channel for broadcasting a live streaming media from a service platform according to an attribute parameter of the live streaming media to be watched; acquire the live streaming media data from a buffer corresponding to the live channel in the service platform according to the identification of the live channel, wherein the live streaming media data comprises at least two paths; decode the live streaming media data; and play the live streaming media data according to the decoded live streaming media data.

The above illustration is only a summary of the technical solutions of the invention. In order to more clearly understand the technical measures of the invention, it may be implemented in accordance with the contents of the disclosure, and in order to make the above and other objects, characteristics and advantages more apparent, specific implementation modes of the invention will be listed below.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of Embodiment 1 of the live streaming media method according to the invention;

FIG. 2 is a flow chart of Embodiment 2 of the live streaming media method according to the invention;

FIG. 3 is a flow chart of Embodiment 3 of the live streaming media method according to the invention;

FIG. 4 is a structural representation of Embodiment 1 of the server according to the invention;

FIG. 5 is a structural representation of Embodiment 2 of the server according to the invention;

FIG. 6 is a structural representation of an embodiment of the terminal according to the invention;

FIG. 7 is a structural representation of a live streaming media system according to the invention;

FIG. 8 is a signaling interaction diagram of streaming media broadcast by the system according to an embodiment of the invention; and

FIG. 9 schematically shows a block diagram of a server according to an embodiment of the invention.

### DETAILED DESCRIPTION

Exemplary embodiments of the disclosure will be further described in detail referring to the drawings. Although exemplary embodiments of the disclosure are shown in the drawings, it should be understood that the disclosure may be realized in various forms, rather than being limited to the embodiments described herein. On the contrary, these embodiments are provided for more thoroughly understanding the disclosure and fully conveying the scope of the disclosure to one skilled in the art.

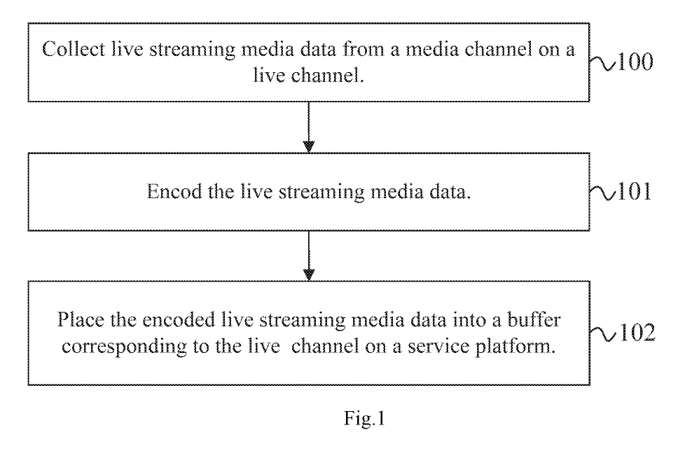

FIG. 1 is a flow chart of Embodiment 1 of the live streaming media method according to the invention. As shown in FIG. 1, the method according to this embodiment may specifically includes the steps of:

100: live streaming media data from a media channel on a live channel is collected;

First of all, in the method according to this embodiment, the technical solution of the invention will be described on the side of a publish server.

In this embodiment, the data includes at least two paths, in other words, the streaming media of this embodiment includes at least two media channels, wherein each media channel is adapted to transmit one path of data. For example, in a live teaching scene, the live streaming media may include an audio stream collected and compressed from a microphone, a video stream acquired and compressed from a camera and a screen image stream acquired from the screen of a personal computer (PC) or a handheld device, wherein the screen image stream may refer to the course content explained by a teacher, or it may be understood as the school teaching-type desktop content. However, the method for live streaming media according to this embodiment may be applied to other live scenes, and it will not be described one by one here.

101: the live streaming media data is encoded;

In practical application, in order to improve the release enthusiasm of personal streaming media resources, a live streaming media system may include a plurality of server. However, the data format of the same path of media channel collected by each server may generally be different, for example, the formats of different audio streams may not be the same, and the formats of different video streams may not be the same, and the format of different screen image streams may not be the same either. Additionally, the data format of the same path of media channel of different streaming media collected by the same server may be different. In order to guarantee that all terminals may watch the live streaming media, in this embodiment, all the data on each media channel of the streaming media to be live broadcasted may be encoded on the side of the server, so that the data format that belongs to the same media channel will be the same after encoding, for example, after the server encodes the data on each media channel, it may guarantee that the formats of different audio streams are the same, the formats of the video streams are the same, and the formats of the screen image streams are the same too, thus it is very convenient for the side of the terminal to decode in the same decoding mode, thereby it is convenient for watching. However, in practical application, the data on the same media channel corresponding to different streaming media may be encoded differently on the side of the server, and the data formats that belong to the same media channel may not be the same after encoding, thus it requires that different decoding modes will be selected for decoding the data that belongs to the same streaming media channel on the side of the terminal, thereby the play of the streaming media may be realized.

102: the encoded live streaming media data is placed in a buffer corresponding to the live channel on the service platform.

For example, the service platform of this embodiment may include one live service module, a buffer corresponding to the live channel is set in the live service module. At this point, the encoded live streaming media data may be specifically placed in the buffer corresponding to the live channel in the live service module in the service platform. The live service module in the service platform of this embodiment is used for storing the live streaming media data. When the streaming media is stored in the live service module, it is stored according to live channels. Each live channel has a corresponding buffer of its own. In the buffer of each live channel, data is stored according to media channels, for example, the data of the audio stream, the video stream and the screen image stream need to be stored respectively, thus it may be convenient for the terminal to decode the data on each media channel.

In the live streaming media method according to this embodiment, live streaming media data from a media channel on a live channel is collected, and the live streaming media data is encoded; the encoded data is placed in the buffer corresponding to the live channel on the service platform, thus the streaming media may be live broadcasted on the side of a server. By the technical solution of this embodiment, it can make up for the deficiencies of the prior art, the flexibility of a streaming media live service may be improved, the transmission of multi-path (two and more paths) of streaming media data may be realized, and by employing the above solution, it can further guarantee the real time and stability of streaming media data transmission during the live broadcast of streaming media.

Based on the above technical solution of the embodiment shown in FIG. 1, wherein Step 101 “the live streaming media data is encoded” may specifically include: the corresponding data is encoded by employing the corresponding compressed encoding standard and encoding parameters according to the format of the data on each media channel, so that the formats of the data that belongs to the same media channel of the encoded different streaming media will be the same, and it is convenient for the terminal side to perform the same decoding for playing.

On the side of the server, in order to make the data format that belongs to the same media channel be the same after encoding, in this embodiment, it needs to encode the corresponding data by employing the corresponding encoding standard and encoding parameters according to the format of the data on the media channel, and the encoding standard and the encoding parameters employed for different data format may not be the same. Specifically, information such as the encoding standard, the encoding parameter and the target format after encoding, etc., of each format of data on each type of media channel may be recorded in a management service module.

Further optionally, based on the technical solution of the above embodiment, wherein, Step 102 “the encoded data is placed in the buffer corresponding to the live channel on the service platform” may specifically include: each encoded data is placed in a buffer corresponding to the live channel in the live service module in the service platform according to a queue discipline of first-in-first-out.

First of all, the data stored in the buffer of the live service module is stored according to live channels, and the data on each live channel is stored according to media channels, and the number of the data buffers on the live channel corresponds to the number of media channels on each live channel. In each data buffer, when the encoded data of this embodiment is placed in the buffer of the corresponding live channel in the live service module, it conforms to the queue discipline of first-in-first-out.

Further optionally, based on the technical solution of the above embodiment, before Step 100 “live streaming media data from a media channel on a live channel is collected”, the method may further includes the steps of:

(1): the identification of the live channel required by the live streaming media is requested from the service platform, and the identification of the live channel returned by the service platform is received;

The service platform of this embodiment may further include a management service module. For example, in the step 1) of this embodiment, specifically, the identification of the live channel required by the live streaming media is requested from the management service module in the service platform, and the identification of the live channel returned by the management service module in the service platform is received.

First of all, the server needs to log on the management server module, the management service module may manage each server via user name and password, thus the server may log on the management service module by using its own user name and password, and request to the management service module for the identification of the live channel needed to live broadcast the streaming media, wherein the live channel identification is a Globally Unique Identifier (GUID), which is used for uniquely identifying a live channel. The management service module may automatically generate a unique live channel identification via a preset generating mechanism for identifying the live channel on which the streaming media is to be live broadcasted.

(2) attribute parameters of the streaming media are sent to the service platform for the service platform to establish and save a correspondence between the identification of the live channel and the attribute parameters of the streaming media;

By the same token, specifically, the attribute parameters of the streaming media may be sent to the management service module in the service platform for the management service module to establish and save a correspondence between the identification of the live channel and the attribute parameters of the streaming media.

Wherein, step (2) and step (1) may be performed simultaneously; in other words, in step (1), when the live channel identification is requested, the attribute parameters of the streaming media may be directly carried in the request; or, just as this embodiment, the live channel identification is requested, and after the management service module assigns the live channel identification, the attribute parameters of the streaming media are sent to the management service module, thus it is convenient for the management server module to establish a correspondence between the identification of the live channel and the attribute parameters of the streaming media. In this embodiment, the attribute parameters of the streaming media may include the identification of the streaming media, for example, parameters such as the name, the upload geographic area of the streaming media and the propaganda page of the streaming media, etc. At the same time, information such as the address and user name of the server that live broadcasts the streaming media, etc., may also be recorded in the management service module.

It should be noted that, the management service module further manages the address information of the live service module. For example, before Step 102 “the encoded data is placed in the buffer corresponding to the live channel on the service platform” in the above embodiment shown in FIG. 1, the server needs to log on the management service module by using the user name and password, acquire the address of the live service module from the management service module and access the live service module according to the address of the live service module, so that each encoded data may be placed in the buffer corresponding to the live channel in the live service module.

(3) The live channel for the live streaming media is selected from the service platform, and the live channel is uniquely identified by the identification of the live channel.

For example, specifically, the live channel for the live streaming media is selected in the live service module in the service platform, and the live channel is uniquely identified by the identification of the live channel.

By the same token, the server may enter the live service module according to the address of the live service module, select one live channel for live broadcasting the streaming media from the live service module, and uniquely identify the live channel by the live channel identification generated by the management service module.

(4) the state of the live channel corresponding to the identification of the live channel in the service platform is set as live state.

For example, specifically, the state of the live channel corresponding to the identification of the live channel in the management service module in the service platform is set as live state.

After the live channel is selected, the server returns to the management service module and sets the state of the live channel corresponding to the live channel identification as live state.

Further optionally, based on the technical solution of the above embodiment, after Step 102 “the encoded data is placed in the buffer corresponding to the live channel on the service platform”, the method may further include: it interacts with the terminal that live broadcasts the streaming media via the service platform.

For example, the service platform further includes an interacting service module. It interacts with the terminal that live broadcasts the streaming media via the service platform, specifically, it may be connected with the interacting service module corresponding to the live channel in the service platform, so that it may interact with the terminal that live broadcasts the streaming media via the interacting service module. Similarly, in the interacting service module, the interacting service module corresponding to each live channel may also be identified by employing the live channel identification. When the terminal logs on the interacting service module corresponding to the live channel and requests to interact with the server, the interacting service module may acquire the address of the server corresponding to the live channel from the management service module and communicate with the server according to the address of the server, thereby realizing the interaction between the server and the terminal.

In the live streaming media method of the above embodiment, the communication among the server, the terminal, the management service module, the live service module and the interacting service module may be realized via Real-time Transport Protocol (RTP), thereby the real time and stability of live streaming media may be guaranteed. In practical application, other communication protocols may also be employed, and it will not be described one by one here.

All of the above optional technical solutions may be combined in any manner to form optional embodiments of the invention, and it will not be described one by one here.

In the live streaming media method of the above embodiment, the streaming media data may be processed on the side of a server by employing the above solution. By the technical solution of this embodiment, it can make up for the deficiencies of the prior art, the flexibility of a streaming media live service may be improved, transmission of two and more paths of streaming media data may be realized, and by employing the above solution, it can further guarantee the real time and stability of streaming media data transmission during the live broadcast of streaming media.

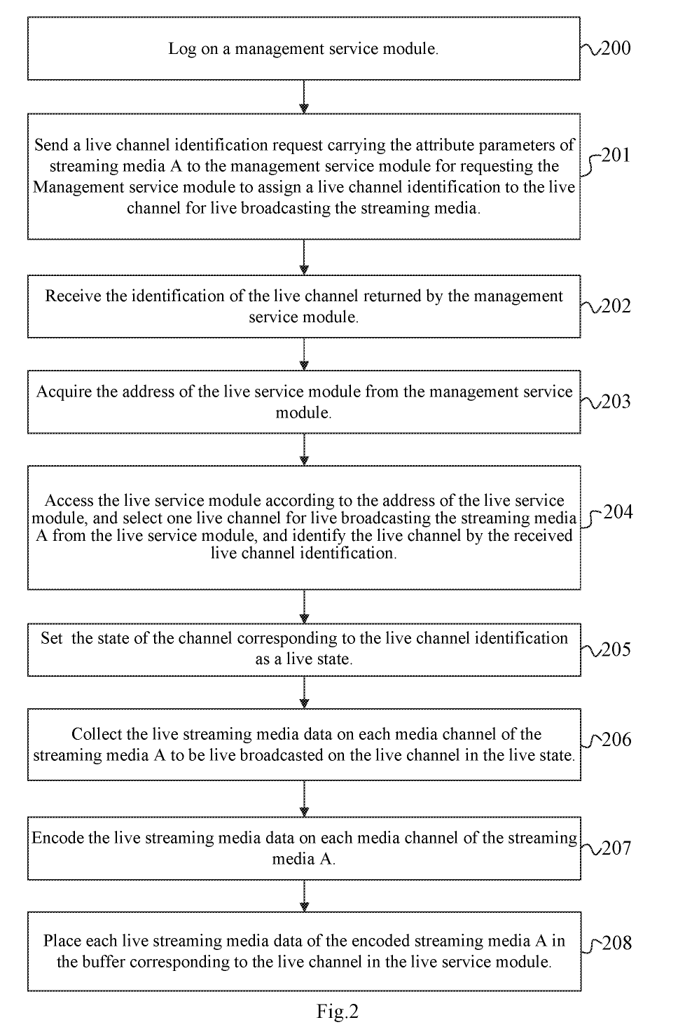

FIG. 2 is a flow chart of Embodiment 2 of the live streaming media method according to the invention. As shown in FIG. 2, based on the technical solution of the above embodiment, the technical solution of the invention will be further introduced in detail by the live streaming media method according to this embodiment. As shown in FIG. 2, the live streaming media method according to this embodiment may specifically includes the steps of:

200: it logs on a management service module;

The executive agent of the live streaming media method according to this embodiment is still a server. For example, the server specifically may log on in a manner of user name plus password. The user name and password of each server will be stored in advance in a management service module, and when the server uses the correct user name and password, it may log on the management service module.

201: A live channel identification request carrying the attribute parameters of streaming media A is sent to the management service module for requesting the management service module to assign a live channel identification to the live channel for live broadcasting the streaming media;

After the management service module receives the live channel identification request, it assigns a live channel identification for uniquely identifying the live channel to the live channel for live broadcasting the streaming media. By the same token, a correspondence between the live channel identification and the attribute parameters of the streaming media A is recorded in the management service module, and at the same time, information such as the address of the server for releasing the streaming media A, etc., is further recorded.

202: the identification of the live channel returned by the management service module is received;

203: the address of the live service module is acquired from the management service module:

The addresses of each live service publish side, the live service module, the interacting service module and each live service terminal will be recorded in the management service module.

204: the live service module is accessed according to the address of the live service module, and one live channel for live broadcasting the streaming media A is selected from the live service module, and the live channel is identified by the received live channel identification;

205: the state of the channel corresponding to the live channel identification is set as a live state;

206: the live streaming media data on each media channel of the streaming media A to be live broadcasted on the live channel in the live state is collected;

207: the live streaming media data on each media channel of the streaming media A is encoded;

208: each live streaming media data of the encoded streaming media A is placed in the buffer corresponding to the live channel in the live service module.

For the specific implementation of Step 206-208, reference may be made to the record in the embodiment shown in the above FIG. 1, and it will not be described again here.

In the live streaming media method according to this embodiment, the streaming media data may be processed on the side of a server by employing the above solution. By the technical solution of this embodiment, it can make up for the deficiencies of the prior art, the flexibility of a streaming media live service may be improved, transmission of two and more paths of streaming media data may be realized, and by employing the above solution, it can further guarantee the real time and stability of streaming media data transmission during the live broadcast of streaming media.

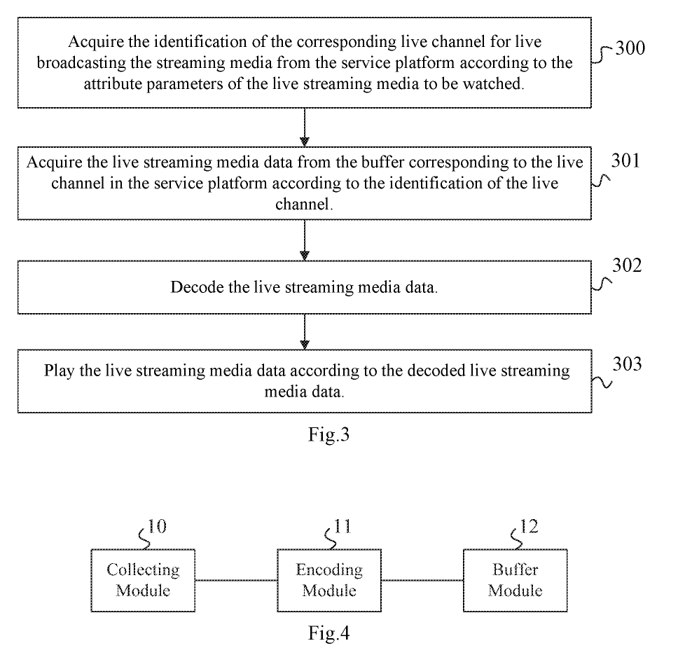

FIG. 3 is a flow chart of Embodiment 3 of the live streaming media method according to the invention. As shown in FIG. 3, the executive agent of the live streaming media method according to this embodiment is a terminal, and the method may specifically includes the steps of:

300: the identification of the corresponding live channel for live broadcasting the streaming media is acquired from the service platform according to the attribute parameters of the live streaming media to be watched;

For example, specifically, the identification of the corresponding live channel for live broadcasting the streaming media may be acquired from the management service module in the service platform.

First of all, the terminal needs to log on the management service module according to the user name and the password. Similarly, the management service module records and manages the user name and address of each terminal. After the terminal logs on the management service module, it selects the live streaming media to be watched. The attribute parameters of the live streaming media to be watched may be seen in the management service module, and the identification of the corresponding live channel for live broadcasting the streaming media may be acquired according to the correspondence between the attribute parameters of the streaming media and the live channel identification for live broadcasting the streaming media.

301: the live streaming media data is acquired from the buffer corresponding to the live channel in the service platform according to the identification of the live channel;

For example, specifically, the live streaming media data may be acquired from the buffer corresponding to the live channel in the live service module in the service platform.

The live streaming media data of this embodiment includes at least two paths; in other words, this embodiment includes at least two media channels, wherein each media channel is adapted to transmit one path of data.

302: the live streaming media data is decoded;

303: the live streaming media data is played according to the decoded live streaming media data.

Specifically, after the terminal synchronously controls the data formed after decoding, it renders and plays the data on each media channel respectively, thereby realizing the live broadcast of the streaming media.

The difference between the live streaming media method according to this embodiment and the above embodiment shown in FIG. 1 lies in that: in the above embodiment shown in FIG. 1, the live streaming media of the invention is described on the server, but in this embodiment, the live streaming media of the invention is described on the terminal.

In the live streaming media method according to this embodiment, the identification of the corresponding live channel for live broadcasting the streaming media is acquired from the service platform according to the attribute parameters of the live streaming media to be watched, and the live streaming media data is acquired from the buffer corresponding to the live channel in the service platform according to the identification of the live channel; the live streaming media data is decoded; the live streaming media data is played according to the decoded live streaming media data, thus the live of the streaming media may be realized on the side of the terminal. By the technical solution of this embodiment, it can make up for the deficiencies of the prior art, the flexibility of a streaming media live service may be improved, transmission of two and more paths of streaming media data may be realized, and by employing the above solution, it can further guarantee the real time and stability of streaming media data transmission during the live broadcast of streaming media.

Optionally, based on the technical solution of the above embodiment shown in FIG. 3, the step 301 “the live streaming media data is acquired from the buffer corresponding to the live channel in the service platform according to the identification of the live channel” may specifically include: according to the identification of the live channel, the data on each media channel of the streaming media are acquired from the buffer of the live channel corresponding to the live channel identification in the live service module in the service platform according to a queue discipline of first-in-first-out.

Further optionally, based on the technical solution of the above embodiment shown in FIG. 3, after step 300 “the identification of the corresponding live channel for live broadcasting the streaming media is acquired from the service platform according to the attribute parameters of the live streaming media to be watched”, the method may further include: it interacts with a publish side for live broadcasting the streaming media via the service platform.

For example, specifically, it may be connected with the interacting service module corresponding to the live channel that corresponds to the live channel identification in the service platform according to the live channel identification, so that it may interact with the publish side for live broadcasting the streaming media via the interacting service module.

Specifically, after the terminal acquires the live channel identification, it further needs to acquire the address of the interacting service module from the management service module and then access the interacting service module according to the address of the interacting service module. Due to the privacy of interaction, each live channel may occupy one interacting service module, and the interacting service module is labeled with the identification of the live-channel. Thus, the terminal may request for interacting with the server via the interacting service module corresponding to the identification of the live channel. After the interacting service module receives the request, it may acquire the address of the server corresponding to the live channel identification from the management service module and communicate with the server according to the address of the server, and finally, the communication between the server and the terminal may be realized. It should be noted that, the carriers of the server may include a PC with a network function or a handheld device with a wireless networking function such as WIFI or 3G, etc. The interaction between the server and the terminal in this embodiment may be text interaction, and it may also be voice interaction. By the interaction between the server and the terminal, interaction such as questioning, releasing a film and online contacting, etc., may be realized.

By the same token, in the live streaming media method of the above embodiment, the communication among the server, the terminal, the management service module, the live service module and the interacting service module may be realized via RTP, thereby it may guarantee the real time and stability of live streaming media.

In the live streaming media method of the above embodiment, by employing the above solution, the live broadcast of the streaming media may be realized on the side of the terminal. By the technical solution of this embodiment, it can make up for the deficiencies of the prior art, the flexibility of a streaming media live service may be improved, transmission of two and more paths of streaming media data may be realized, and by employing the above solution, it can further guarantee the real time and stability of streaming media data transmission during the live broadcast of streaming media.

FIG. 4 is a structural representation of Embodiment 1 of the server according to the invention. As shown in FIG. 4, the server of this embodiment may specifically include: a collecting module 10, an encoding module 11 and a buffer module 12.

Wherein, the collecting module 10 is configured for collecting live streaming media data from a media channel on a live channel, wherein the live streaming media data includes at least two paths; the encoding module 11 is configured for encoding the live streaming media data collected by the collecting module 10; the buffer module 12 is configured for placing the encoded live streaming media data by the encoding module 11 in the buffer corresponding to the live channel in the service platform, wherein, the encoded live streaming media data is saved according to the media channel respectively.

In the server of this embodiment, the realization mechanism for realizing streaming media live broadcast by employing the above modules is the same as the realization mechanism in the above embodiment of the live streaming media method shown in FIG. 1; reference may be made to the record of the above embodiment shown in FIG. 1 for the details thereof, and it will not be described again here.

In the server of this embodiment, by employing the above modules, live streaming media data from a media channel on a live channel are collected, and the live streaming media data collected is encoded; the encoded live streaming media data is placed in a buffer corresponding to the live channel on the service platform, thus the streaming media may be live broadcasted on the side of a server. By the technical solution of this embodiment, it can make up for the deficiencies of the prior art, the flexibility of a streaming media live service may be improved, transmission of two and more paths of streaming media data may be realized, and by employing the above solution, it can further guarantee the real time and stability of streaming media data transmission during the live broadcast of streaming media.

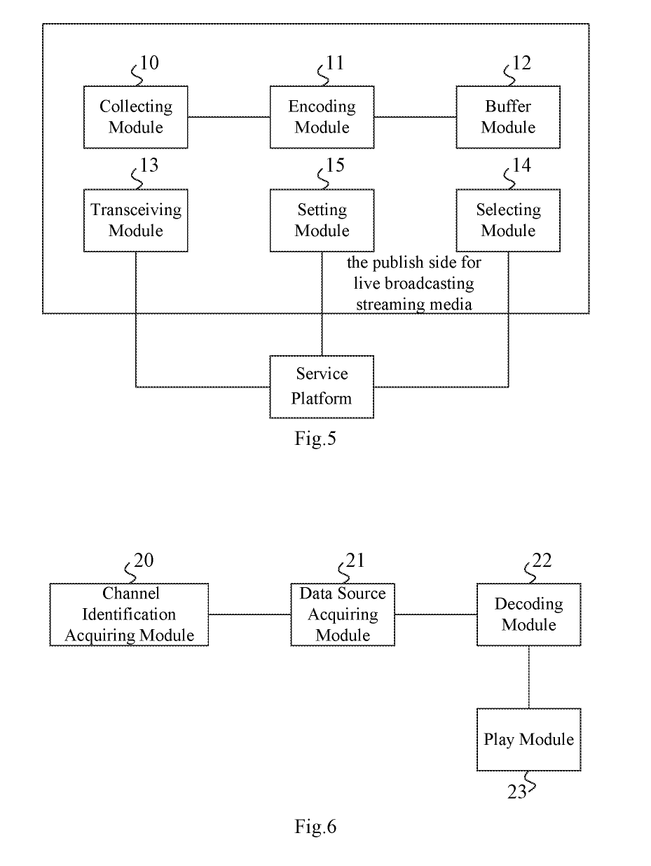

FIG. 5 is a structural representation of Embodiment 2 of the server according to the invention. As shown in FIG. 5, based on the above embodiment FIG. 4, the technical solution of the invention will be further described in detail by the server of this embodiment.

First of all, in the server of this embodiment, the encoding module 11 is specifically configured for encoding the corresponding data collected by the collecting module 10 by employing the corresponding compressed encoding standard and encoding parameters according to the format of the data on each media channel.

Further optionally, in the server of this embodiment, the buffer module 12 is specifically configured for placing each encoded data by the encoding module 11 in the buffer corresponding to the live channel in the live service module according to a queue discipline of first-in-first-out.

As shown in FIG. 5, in the server of this embodiment, the server further includes: a transceiving module 13, a selecting module 14 and a setting module 15.

Wherein, the transceiving module 13 is configured for requesting the identification of the live channel from the service platform and receiving the identification of the live channel returned by the service platform; the transceiving module 13 is further configured for sending the attribute parameters of the live streaming media to the service platform for the service platform to establish and save a correspondence between the identification of the live channel and the attribute parameters of the live streaming media; the selecting module 14 is configured for selecting the live channel for live broadcasting the streaming media from the service platform and uniquely identifying the live channel by the identification of the live channel; the setting module 15 is configured for setting the state of the live channel corresponding to the identification of the live channel in the service platform as a live state.

As shown in FIG. 5, the server of this embodiment further includes: a first interacting module 16, which is configured for interacting with the terminal that live broadcasts the streaming media via the service platform.

In the server of this embodiment, the realization mechanism for realizing streaming media live broadcast by employing the above modules is the same as the realization mechanism of the above embodiment shown in FIG. 2, reference may be made to the record of the above embodiment shown in FIG. 2 for the details thereof, and it will not be described again here.

In the server of this embodiment, the streaming media data may be processed on the side of a server by employing the above solution. By the technical solution of this embodiment, it can make up for the deficiencies of the prior art, the flexibility of a streaming media live service may be improved, transmission of two and more paths of streaming media data may be realized, and by employing the above solution, it can further guarantee the real time and stability of streaming media data transmission during the live broadcast of streaming media.

FIG. 6 is a structural representation of an embodiment of the terminal according to the invention. As shown in FIG. 6, the terminal of this embodiment may specifically include: a live channel identification acquiring module 20, a data acquiring module 21, a decoding module 22 and a play module 23.

Wherein, the live channel identification acquiring module 20 is configured for acquiring an identification of a live channel for live broadcasting the live streaming media from a service platform according to an attribute parameter of the live streaming media to be watched; the data acquiring module 21 is configured for acquiring the live streaming media data from the buffer of the live channel corresponding to the live channel identification in the service platform according to the identification of the live channel acquired by the live channel identification acquiring module 20, wherein the live streaming media data includes at least two paths; the decoding module 22 is configured for decoding the live streaming media data acquired by the data acquiring module 21; the play module 23 is configured for playing the live streaming media data according to the decoded live streaming media data by the decoding module 22.

In the terminal of this embodiment, the realization mechanism for realizing streaming media live broadcast by employing the above modules is the same as the realization mechanism of the above embodiment shown in FIG. 3, reference may be made to the record of the above embodiment shown in FIG. 3, and it will not be described again here.

In the terminal of this embodiment, by employing the above modules, the identification of the corresponding live channel for live broadcasting the streaming media may be acquired from the service platform according to the attribute parameters of the live streaming media to be watched, and the live streaming media data is acquired from the buffer corresponding to the live channel in the service platform according to the identification of the live channel; the live streaming media data is decoded; the live streaming media data is played according to the decoded live streaming media data, thus the live broadcast of the streaming media may be realized on the side of the terminal. By the technical solution of this embodiment, it can make up for the deficiencies of the prior art, the flexibility of a streaming media live service may be improved, transmission of two and more paths of streaming media data may be realized, and by employing the above solution, it can further guarantee the real time and stability of streaming media data transmission during the live broadcast of streaming media.

Optionally, based on the above embodiment shown in FIG. 6, the data acquiring module 21 is specifically configured for acquiring, according to the identification of the live channel, the data on each media channel of the streaming media from the buffer of the live channel corresponding to the live channel identification in the live service module according to a queue discipline of first-in-first-out.

Moreover, based on the above embodiment shown in FIG. 6, the terminal may further include: a second interacting module, which is configured for interacting with the publish side for live broadcasting the streaming media via the service platform. For example, specifically, it may be connected with the interacting service module corresponding to the live channel according to the live channel identification, so that it may interact with the publish side for live broadcasting the streaming media via the interacting service module. Reference may be made to the record of the above related method embodiment, and it will not be described again here.

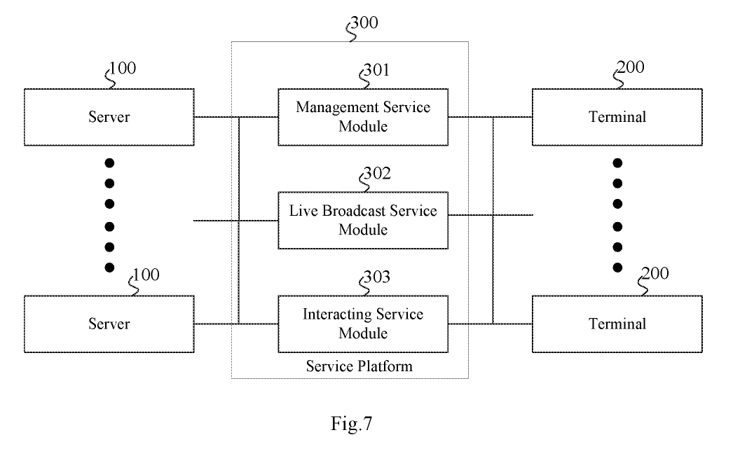

FIG. 7 is a structural representation of a system for live broadcasting streaming media according to the invention. As shown in FIG. 7, the system for live broadcasting streaming media of this embodiment may specifically include a plurality of servers 100, a plurality of terminals 200 and a service platform 300. The service platform 300 includes a management service module 301, a live service module 302 and an interacting service module 303.

Wherein, the server 100 may employ the server of the above embodiment shown in FIG. 4 or FIG. 5; the terminal 200 may employ the terminal of the above embodiment shown in FIG. 6; the management service module 301 is respectively connected with the server 100 and the terminal 200 for realizing the management on the identification of the live channel of the live streaming media and the attribute parameters of the streaming media; the live service module 302 is respectively connected with the server 100 and the terminal 200 for realizing the management on the live streaming media data on the live channel; the interacting service module 303 is respectively connected with the server 100 and the terminal 200 for realizing the interaction between the server 100 and the terminal 200, moreover, the communication between all the connection of this embodiment may be realized via RTP, thus the real time and stability of streaming media live broadcast may be reinforced. Specifically, live broadcast of the streaming media may be realized by referring to the method for live streaming media of the above embodiments shown in FIG. 1-FIG. 3, and it will not be described again here.

It should be noted that, in practical application, the number of the server 100 and the terminal 200 may be set according to actual demand, which is not limited here. For uniform management, the number of the management service module 301 and the live service module 302 may be one, and the number of the interacting service module 303 may be one, or it may also be more than one. If the number of the interacting service module 303 is one, a plurality of interacting service units may be set internally, and the live channel for each live streaming media may correspond to one interacting service unit. If a plurality of interacting service modules 303 is included, each the interacting service module 303 may directly correspond to one live channel for the live streaming media. In this embodiment, it takes one interacting service module 303 as an example.

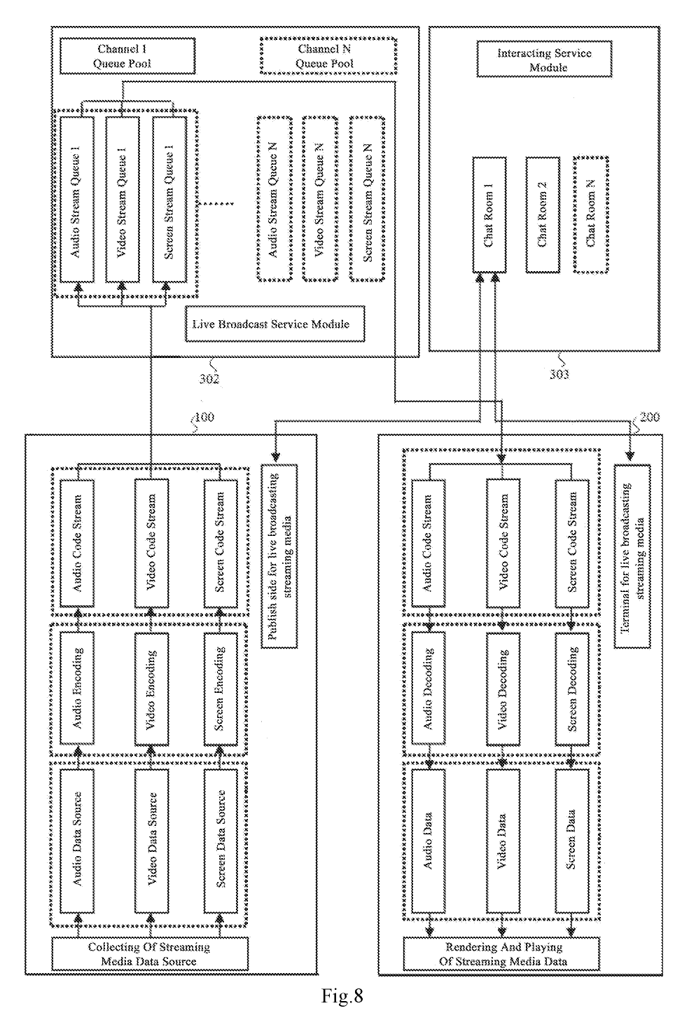

FIG. 8 is a signaling interaction diagram of streaming media live broadcast by the system for live streaming media according to an embodiment of the invention. As shown in FIG. 8, in the system for live streaming media of this embodiment, the live broadcast of one remote real-time teaching is taken as an example. The technical solution of the invention is described by an example in which the streaming media of this embodiment includes at least two paths of media channels for transmitting audio stream data and at least two paths of video sources such as video stream data and screen data.

As shown in FIG. 8, in this embodiment, the technical solution of the invention is described by an example in which one server 100 and one terminal 200 are included and the service platform 300 includes one live service module 302 and one the interacting service module 303. Additionally, FIG. 8 shows the management service module.

As shown in FIG. 8, the server 100 logs on the stream management service module, and the live channel with a live channel identification of 1, i.e., the live channel 1, is determined for live broadcasting the streaming media of the real-time teaching, and a correspondence between the management service module and the attribute parameters of the streaming media is established in the management service module. Then, in the server 100, the streaming media data is collected by at least two paths of channels respectively, and the audio data, the video data and the screen data are obtained, then audio encoding is performed on the audio data collected, video encoding is performed on the video data and screen encoding is performed on the screen data, thus an audio code stream, a video code stream and a screen code stream will be formed respectively. Next, the server 100 acquires the address of the live service module 302 from the management service module, accesses the live service module 302 according to the address and defines a buffer of the live channel 1 in the live service module 302, thereby the code streams of the live streaming media on the live channel 1 may be stored. At this point, the server 100 places the audio code stream, the video code stream and the screen code stream in the buffer corresponding to the live channel 1 in the live service module 302. Because the code streams on each media channel are stored according to a queue discipline of first-in-first-out, the buffer corresponding to the live channel 1 may also be referred to as a queue pool of the live channel 1. As shown in FIG. 8, the queue pool of the live channel 1 may include an audio stream queue 1, a video stream queue 1 and a screen stream queue 1 corresponding to the live channel 1. Here, 1 all represents the identification of the live channel. In practical application, the system for live streaming media may simultaneously live broadcast a plurality of streaming media, thus a plurality of live channels may also be included here, for example, N live channels may be included totally, wherein N is an positive integer greater than 1. Corresponding to each live channel, a corresponding buffer is included in the live service module 302 respectively, for example, the queue pool of the live channel N may include an audio stream queue N, a video stream queue N and a screen stream queue N corresponding to the live channel N.

The terminal 200 logs on the management service module and acquires the identification of the live channel on which the live broadcast to be watched exists from the management service module, for example, the identification of the live channel to be watched is 1. Then, it acquires the address of the live service module 302 from the management service module, accesses the live service module 302 according to the address of the live service module 302, and acquires the audio code stream, the video code stream and the screen code stream from the buffer corresponding to the live channel 1, i.e., the queue pool of the live channel 1. Next, audio decoding, video decoding and screen decoding are performed on the audio code stream, the video code stream and the screen code stream respectively, and finally the audio data, the video data and the screen data are obtained; then the terminal 200 performs streaming media data rendering and playing on at least two paths of data of the audio data, the video data and the screen data.

Additionally, it should be noted that, after the terminal 200 acquires the identification of the live channel 1, it further acquires the address of the interacting service module 303 and the address of the server 100 from the management service module, then it accesses the interacting service module 303 according to the address of the interacting service module 303 and the address of the server 100 and selects one interacting service unit for interacting with the server 100 from the interacting service module 303. In order to vividly describe the interaction scene of the interacting service unit according to this embodiment, as shown in FIG. 8, the interacting service unit may be referred to as a chat room, and the chat rooms may be distinguished by the identification of the live channel, for example, chat room 1 represents the chat room corresponding to the live channel 1. Thus, when the server 100 and the terminal 200 live broadcast the streaming media via the live channel 1, they may interact via the chat room 1 in the interacting service module 303. By the same token, when N channels exist correspondingly, the interacting service module 303 may also include N chat rooms correspondingly.

In practical application, the system for live streaming media of this embodiment may also live broadcast at least two paths of streaming media data, and specifically, the data transmission protocol employed for live broadcasting may be RTP or other transmission protocols.

For the specific realization mode of the system for live streaming media of this embodiment, reference may also be made to the record of the above embodiments shown in FIG. 1-FIG. 7.

In the system for live streaming media of this embodiment, the live broadcast of multi-path streaming media may be realized by employing the above technical solution. Therefore, by the technical solution of this embodiment, it can make up for the deficiencies of the prior art, and the flexibility of a streaming media live service may be improved, transmission of two and more paths of streaming media data may be realized, and by employing the above solution, it can further guarantee the real time and stability of streaming media data transmission during the live broadcast of streaming media.

Further, an embodiment of the present disclosure further provides a non-transitory computer-readable storage medium storing executable instructions, which can be executed by an electronic device to perform any methods for live streaming media mentioned by embodiments of the present disclosure.

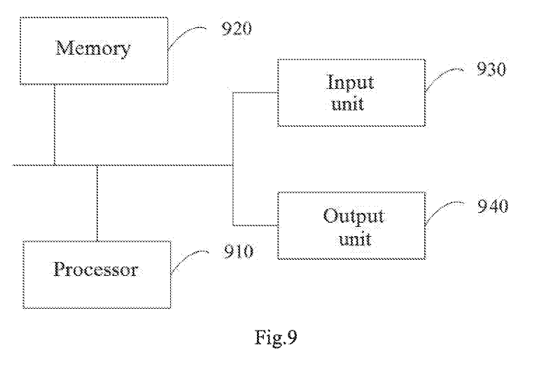

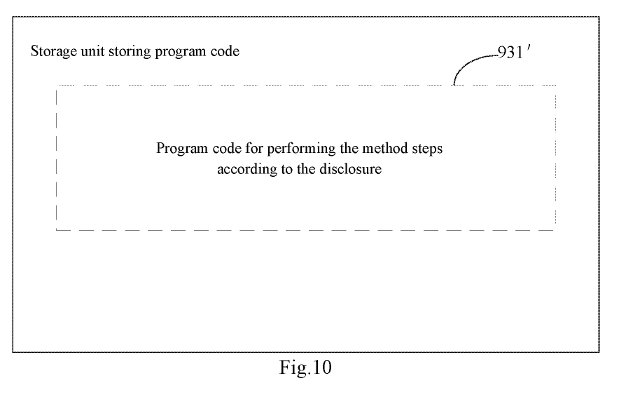

FIG. 9 is a block diagram of hardware structure of a server for live streaming media according to another embodiment of the present disclosure. As shown in FIG. 9, the server includes: one or more processors 910 and memory 920. A processor 910 is showed in FIG. 9 for an example.

The server can also include: input unit 930 and output unit 940.

Processor 910, memory 920, input unit 930 and output unit 940 can be connected by BUS or other methods, and BUS connecting is showed in FIG. 9 for an example.

Memory 920 can be used for storing non-transitory software program, non-transitory computer executable program and modules as a non-transitory computer-readable storage medium, such as corresponding program instructions/modules for the methods for live streaming media mentioned by embodiments of the present disclosure (such as shown in FIG. 4 and FIG. 5, collecting module 10, encoding module 11, buffer module 12, transceiving module 13, selecting module 14 and setting module 15). Processor 910 performs kinds of functions and data processing by executing non-transitory software program, instructions and modules which are stored in memory 920, thereby realizes the methods for live streaming media mentioned by embodiments of the present disclosure.

Memory 920 can include program storage area and data storage area, thereby the operating system and applications required by at least one function can be stored in program storage area and data created by using the device for live streaming media can be stored in data storage area. Furthermore, memory 920 can include high speed Random-access memory (RAM) or non-volatile memory such as magnetic disk storage device, flash memory device or other non-volatile solid state storage devices. In some embodiments, memory 920 can include long-distance setup memories relative to processor 910, which can communicate with the device for live streaming media by networks. The examples of said networks are including but not limited to Internet, Intranet, LAN, mobile Internet and their combinations.

Input unit 930 can be used to receive inputted number, character information and key signals causing user configures and function controls of the device for live streaming media. Output unit 940 can include a display screen or a display device.

The said module or modules are stored in memory 920 and perform the methods for live streaming media when executed by one or more processors 910.

The said device can reach the corresponding advantages by including the function modules or performing the methods provided by embodiments of the present disclosure. Those methods can be referenced for technical details which may not be completely described in this embodiment.

FIG. 10 is a block diagram of hardware structure of a terminal for live streaming media according to another embodiment of the present disclosure. As shown in FIG. 10, the terminal includes: one or more processors 1010 and memory 1020. A processor 1010 is showed in FIG. 10 for an example.

The terminal can also include: input unit 1030 and output unit 1040.

Processor 1010, memory 1020, input unit 1030 and output unit 1040 can be connected by BUS or other methods, and BUS connecting is showed in FIG. 10 for an example.

Memory 1020 can be used for storing non-transitory software program, non-transitory computer executable program and modules as a non-transitory computer-readable storage medium, such as corresponding program instructions/modules for the methods for live streaming media mentioned by embodiments of the present disclosure (such as shown in FIG. 6, live channel identification acquiring module 20, data acquiring module 21, decoding module 22 and play module 23). Processor 1010 performs kinds of functions and data processing by executing non-transitory software program, instructions and modules which are stored in memory 1020, thereby realizes the methods for live streaming media mentioned by embodiments of the present disclosure.

Memory 1020 can include program storage area and data storage area, thereby the operating system and applications required by at least one function can be stored in program storage area and data created by using the device for live streaming media can be stored in data storage area. Furthermore, memory 1020 can include high speed Random-access memory (RAM) or non-volatile memory such as magnetic disk storage device, flash memory device or other non-volatile solid state storage devices. In some embodiments, memory 1020 can include long-distance setup memories relative to processor 1010, which can communicate with the device for live streaming media by networks. The examples of said networks are including but not limited to Internet, Intranet, LAN, mobile Internet and their combinations.

Input unit 1030 can be used to receive inputted number, character information and key signals causing user configures and function controls of the device for live streaming media t. Output unit 1040 can include a display screen or a display device.

The said module or modules are stored in memory 1020 and perform the methods for live streaming media when executed by one or more processors 1010.

The said device can reach the corresponding advantages by including the function modules or performing the methods provided by embodiments of the present disclosure. Those methods can be referenced for technical details which may not be completely described in this embodiment.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure

1-10. (canceled)

11. A live streaming media method, which is applied to a server, wherein the method comprises:
collecting live streaming media data from a media channel on a live channel, wherein the live streaming media data comprises at least two paths;
encoding the live streaming media data; and
placing the encoded live streaming media data into a buffer corresponding to the live channel on a service platform, wherein the encoded live streaming media data are respectively saved according to the media channel.

12. The method according to claim 11, wherein before collecting live streaming media data from a media channel on a live channel, the method further comprises:
requesting to the service platform an identification of the live channel, and receiving the identification of the live channel returned by the service platform;
sending an attribute parameter of the live streaming media to the service platform, such that the service platform establishes and saves a correspondence between the identification of the live channel and the attribute parameter of the live streaming media;
selecting the live channel for live broadcasting the streaming media from the service platform, and uniquely identifying the live channel by the identification of the live channel; and
setting the state of the live channel corresponding to the identification of the live channel on the service platform as a live state.

13. The method according to claim 12, wherein after placing the data encoded into the buffer corresponding to the live channel on the service platform, the method further comprises:
interacting, via the service platform, with a terminal for broadcasting the streaming media live.

14. A live streaming media method, which is applied to a terminal, wherein the method comprises:
acquiring an identification of a live channel for broadcasting a live streaming media from a service platform according to an attribute parameter of the live streaming media to be watched;
acquiring the live streaming media data from a buffer corresponding to the live channel in the service platform according to the identification of the live channel, wherein the live streaming media data comprises at least two paths;
decoding the live streaming media data; and
playing the live streaming media data according to the decoded live streaming media data.

15. The method according to claim 14, wherein after acquiring an identification of a live channel for broadcasting a streaming media from a service platform according to an attribute parameter of the live streaming media to be watched, the method further comprises:
interacting with a publish side for live broadcasting the streaming media via the service platform.

16. A server, comprising:
at least one processor; and
a memory communicably connected with the at least one processor for storing instructions executable by the at least one processor, wherein execution of the instructions by the at least one processor causes the at least one processor to:
collect live streaming media data from a media channel on a live channel, wherein the live-streaming media data comprises at least two paths;
encode the live streaming media data; and
place the encoded live streaming media data into a buffer corresponding to the live channel on a service platform, wherein the encoded live streaming media data are respectively saved according to the media channel.

17. The server according to claim 16, wherein, before collecting live streaming media data from a media channel on a live channel, the at least one processor is further caused to:
request to the service platform an identification of the live channel, and receiving the identification of the live channel returned by the service platform;
send an attribute parameter of the live streaming media to the service platform, such that the service platform establishes and saves a correspondence between the identification of the live channel and the attribute parameter of the live-streaming media;
select the live channel for live broadcasting the streaming media from the service platform, and uniquely identify the live channel by the identification of the live channel; and
set the state of the live channel corresponding to the identification of the live channel on the service platform as a live state.

18. The server according to claim 17, wherein after placing the data encoded into the buffer corresponding to the live channel on the service platform, the at least one processor is further caused to:
publish side interact, via the service platform, with a terminal for live broadcasting the streaming media live.

19. A terminal, comprising:
at least one processor; and
a memory communicably connected with the at least one processor for storing instructions executable by the at least one processor, wherein execution of the instructions by the at least one processor causes the at least one processor to:
acquire an identification of a live channel for live broadcasting a live streaming media from a service platform according to an attribute parameter of the live streaming media to be watched;
acquire the live streaming media data from a buffer corresponding to the live channel in the service platform according to the identification of the live channel, wherein the live streaming media data comprises at least two paths;
decode the live streaming media data; and
play the live streaming media data according to the decoded live streaming media data.

20. The terminal according to claim 19, wherein, after acquiring an identification of a live-channel for live broadcasting a streaming media from a service platform according to an attribute parameter of the live-streaming media to be watched, the at least one processor is further caused to:
interact with a publish side for live broadcasting the streaming media via the service platform.
